(19) United States
(12) Patent Application Publication
(10) Pub. No.: US 2014/0303958 A1
(43) Pub. Date: Oct. 9, 2014

(54) CONTROL METHOD OF INTERPRETATION APPARATUS, CONTROL METHOD OF INTERPRETATION SERVER, CONTROL METHOD OF INTERPRETATION SYSTEM AND USER TERMINAL

(71) Applicant: SAMSUNG ELECTRONICS CO., LTD., Suwon-si (KR)

(72) Inventors: Yong-hoon LEE, Seoul (KR); Byung-jin HWANG, Suwon-si (KR); Young-jun RYU, Suwon-si (KR); Gyung-chan SEOL, Seoul (KR)

(73) Assignee: SAMSUNG ELECTRONICS CO., LTD., Suwon-si (KR)

(21) Appl. No.: 14/243,392

(22) Filed: Apr. 2, 2014

(30) Foreign Application Priority Data
Apr. 3, 2013 (KR) 10-2013-0036477

(51) Int. Cl. G06F 17/28; G10L 13/08; G10L 15/26

(52) U.S. Cl. CPC G06F 17/289; G10L 15/26; G10L 13/086
USPC 704/2

(57) ABSTRACT

A method of controlling an interpretation apparatus is provided. The control method includes collecting a voice of a speaker in a first language in order to generate voice data, extracting voice attribution information of the speaker from the generated voice data, and transmitting to an external apparatus text data in which the voice of the speaker included in the generated voice data is translated in a second language, together with the extracted voice attribute information. The text data translated in the second language is generated by recognizing the voice of the speaker included in the generated voice data, converting the recognized voice of the speaker into the text data, and translating the converted text data in the second language.

### CROSS-REFERENCE TO RELATED APPLICATION

This application claims priority from Korean Patent Application No. 10-2013-0036477, filed on Apr. 3, 2013, in the Korean Intellectual Property Office, the disclosure of which is incorporated herein by reference in its entirety.

### BACKGROUND

1. Field

Apparatuses and methods consistent with exemplary embodiments relate to an electronic apparatus, and more particularly, to a control method of an interpretation apparatus, a control method of an interpretation server, a control method of an interpretation system and a user terminal, which provide an interpretation function which enables users using languages different from each other to converse with each other.

2. Description of the Related Art

Interpretation systems which allow persons using different languages to freely converse with each other have been evolving for a long time in the field of artificial intelligence. In order for users using different languages to converse with each other in their own languages, machine technology for understanding and interpreting human voices is necessary. However, expression of the human languages may be changed according to the formal structure of a sentence as well as a nuances or a context of the sentence. As a result, it is difficult to accurately interpret semantics of the language uttered by mechanical matching. There are various algorithms for voice recognition, but according to this, high performance hardware and massive data base operation are essential to increase the accuracy of the voice recognition.

However, the unit cost for devices with high-capacity data storage and a high-performance hardware configuration, has increased. It is inefficient for the devices include a high-performance hardware configuration for interpretation functions even when the trend to converge various functions on the devices is being considered. This type of device is also suitable for recent distributed network environments such as ubiquitous computing or cloud systems.

Therefore, a terminal receives assistance from an interpretation server connected to a network in order to provide an interpretation service. The terminal in the systems in the related art collects voices of the user, and transmits the collected voices. The server recognizes the voice, and transmits a result of the translation to another user terminal.

However, when voice data is continuously transmitted or received through a collection of user voices as described above, the amount of data transmission is increased, and thus a network load is increased. In response to an increase in users using the interpretation system, a separate communication network comparable to a current mobile communication network may be necessary in a worst case scenario.

Therefore, there is a need for an interpretation system which allows users using languages different from each other to freely converse with each other using their own devices connected to a network, with a lesser amount of data transmission.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a method of controlling an interpretation apparatus, a method of controlling an interpretation server, a method of controlling an interpretation system, and a user terminal, which allows users using languages different to freely converse with each other using their own devices connected to a network with a lesser amount of data transmission.

According to an aspect of an exemplary embodiment, there is provided an interpretation method by a first device. The interpretation method may include: collecting a voice of a speaker in a first language to generate voice data; extracting from the generated voice data voice attribution information of the speaker, and transmitting to a second device text data in which the voice of the speaker included in the generated voice data is translated in a second language, together with the extracted voice attribute information. The text data translated in the second language may be generated by recognizing the voice of the speaker included in the generated voice data, converting the recognized voice of the speaker into the text data and translating the converted text data into the second language.

The voice attribute information of the speaker may include at least one attribute selected from the group consisting of dynamics, an accent, an intonation, a duration, a boundary, a delay time between sentence configurations, and utterance speed of the voice of the speaker. The voice attribute information of the speaker may be expressed by at least one attribute selected from the group consisting of energy in a frequency of the voice data, a zero-crossing rate (ZCR), a pitch and a formant.

The translating in the second language may include performing a semantic analysis on the converted text data in order to detect a context in which a conversation is done, and translating the text data in the second language by considering the detected context. As described above, the process may be performed by a server or by the first device.

The transmitting may include transmitting the generated voice data to a server in order to request the required translation, receiving the text data in which the generated voice data is converted into text data and the converted text data from the server is again converted in the second language and transmitting to the second device the received text data together with the extracted voice attribute information.

The interpretation method may further include imaging the speaker to generate a first image; imaging the speaker to generate a second image, and detecting from the first image change information in the second image and transmitting to the second device the first image and the detected change information.

The interpretation method may further include transmitting to the second device synchronization information for output synchronization between voice information included in the text data translated in the second language and image information included in the first image or the second image.

According to another aspect of an exemplary embodiment, there is provided a method of controlling an interpretation apparatus. The control method may include: receiving from a first device text data translated in a second language together with voice attribute information; synthesizing a voice in the second language from the received attribute information of the speaker and the text data translated into the second language; and outputting the voice synthesized in the second language.

The voice attribute information of the speaker may include at least one attribute selected from the group consisting of a dynamics, an accent, an intonation, a duration, a boundary, a delay time between sentence configurations and utter speed in the voice of the speaker. The voice attribute information of the speaker may be expressed by at least one selected from the group consisting of energy in a frequency of the voice data, a zero-crossing rate (ZCR), a pitch and a formant.

The control method may further include receiving a first image generated by imaging the speaker; change information between the first image and a second image generated by imaging the speaker, and displaying an image of the speaker based on the received first image and the change information.

The displayed image of the speaker may be an avatar image.

According to another aspect of an exemplary embodiment, there is provided a method of controlling an interpretation server. The control method may include: receiving from a first device voice data related to a speaker where the received voice data is recorded in a first language recognizing a voice of the speaker included in the received voice data and converting the recognized voice of the speaker into text data; translating the converted text data in a second language; transmitting to the first device the text data translated in the second language.

The translating may include performing a semantic analysis on the converted text data in order to detect context in which a conversation is made, and translating the text data in the second language by considering the detected context.

According to another aspect of an exemplary embodiment, there is provided a method of controlling an interpretation system. The interpretation method may include: collecting a voice of a speaker in a first language to generate voice data, and extracting voice attribute information of the speaker from the generated voice data, in a first device; receiving the voice data recorded in the first language from the first device, recognizing the voice of the speaker included in the received voice data, and converting the recognized voice of the speaker into text data, in a speech to text (STT) server; receiving the converted text data, translating the received text data in a second language, and transmitting from the first device to the second device the text data translated in the second language, in the interpretation server; transmitting to a second device from a first device the text data translated in the second language together the voice attribute information of the speaker; and synthesizing a voice in the second language from the voice attribute information and the text data translated in the second language, and outputting a synthesizing voice to the second device.

According to an aspect of another exemplary embodiment, there is provided a user terminal. The user terminal may include: a voice collector configured to collect a voice of a speaker in a first language in order to generate voice data; a communicator configured to communicate with another user terminal; and a controller configured to extract voice attribute information of the speaker from the generated voice data, and to transmitting to the other user terminal text data, in which the voice of the speaker included in the generated voice data is translated in a second language, together with the extracted voice attribute information. The text data translated in the second language may be generated by recognizing the voice of the speaker included in the generated voice data, converting the recognized voice of the speaker into the text data, and translating the converted text data in the second language.

The voice attribute information of the speaker may include at least one attribute selected from the group consisting of a dynamics, an accent, an intonation, a duration, a boundary, a delay time between sentence configurations, and utter speed in the voice of the speaker.

The voice attribute information of the speaker may be expressed by at least one attribute selected from the group consisting of energy in a frequency of the voice data, a zero-crossing rate (ZCR), a pitch and a formant.

The controller may perform a control function to transmit from the server the generated voice data to a server to require translation, to receive the text data, in which the generated voice data is converted into text data, and the converted text data is converted in the second language again and to transmit to the user terminal the received text data together with the extracted voice attribute information.

The user terminal may further include an imager configured to image the speaker in order to generate a first image and a second image. The controller may be configured to detect change information from the first image, and configured to transmit to the other user terminal the first image and the detected change information.

The controller may be configured to transmit to the other user terminal synchronization information for output synchronization between voice information included in the text data translated in the second language and image information included in the first image or the second image.

According to an aspect of another exemplary embodiment, there is provided a user terminal. The user terminal may include: a communicator configured to text data from another user terminal that translated in a second language together with voice attribute information of a speaker; and a controller configured to synthesize a voice in the second language from the received voice attribute information of the speaker, and the synthesizer the text data in the second language, and to output the synthesized voice. The communicator may further receive a first image generated by imaging the speaker, and change information between the first image and a second image generated by imaging the speaker. The controller may be configured to display an image of the speaker based on the received first image and the change information.

According to an aspect of another exemplary embodiment, there is provided a method of controlling an interpretation apparatus, the method including: collecting a voice of a speaker in a first language; extracting voice attribute information of the speaker; and transmitting to an external apparatus text data in which the voice of the speaker is translated in a second language, together with the extracted voice attribute information.

The voice of the first speaker may be collected in order to generate voice data and the transmitted text data may be included in the generated voice data.

The text data translated into the second language may be generated by recognizing the voice of the speaker included in the generated voice data.

The text data translated into the second language may be generated by converting the recognized voice of the speaker into the text data. The text data translated into the second language may be generated by translating the converted text data into the second language.

The method of controlling an interpretation apparatus may further include: setting basic voice attribute information according to attribute information of finally uttered information; and transmitting to the external apparatus the set basic voice attribute information.

Each of the basic voice attribute information and the voice attribute information of the speaker may include at least one attribute selected from the group consisting of a dynamics, an accent, an intonation, a duration, a boundary, a delay time between sentence configurations, and utterance speed in the voice of the speaker.

In addition, each of the basic voice attribute information and the voice attribute information of the speaker may be expressed by at least one attribute selected from the group consisting of energy in a frequency of the voice data, a zero-crossing rate (ZCR), a pitch and a formant.

Additional aspects and advantages of the exemplary embodiments will be set forth in the detailed description, will be obvious from the detailed description, or may be learned by practicing the exemplary embodiments.

### BRIEF DESCRIPTION OF THE DRAWING FIGURES

The above and/or other aspects will be more apparent by describing in detail exemplary embodiments, with reference to the accompanying drawings, in which:

FIG. 1 is a block diagram which illustrates a configuration of an interpretation system, according to a first exemplary embodiment;

FIG. 2 is a view which illustrates a configuration of an interpretation system, according to a second exemplary embodiment;

FIG. 3 is a view which illustrates a configuration of an interpretation system, according to a third exemplary embodiment;

FIG. 4 is a block diagram which illustrates a configuration of a first device, according, to the above-described exemplary embodiments;

FIG. 5 is a block diagram which illustrates a configuration of a first device, or a second device according to the above-described exemplary embodiments;

FIG. 6 is a view which illustrates an interpretation system, according to a fourth exemplary embodiment;

FIG. 7 is a flowchart which illustrates a method of interpretation of a first device, according to another exemplary embodiment;

FIG. 8 is a flowchart which illustrates a method of interpretation of a second device, according to another exemplary embodiment;

FIG. 9 is a flowchart which illustrates a method of interpretation of a server, according to another exemplary embodiment; and

FIG. 10 is a flowchart which illustrates a method of interpretation of an interpretation system, according to another exemplary embodiment.

### DETAILED DESCRIPTION OF THE EXEMPLARY EMBODIMENTS

Hereinafter, exemplary embodiments will be described in more detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

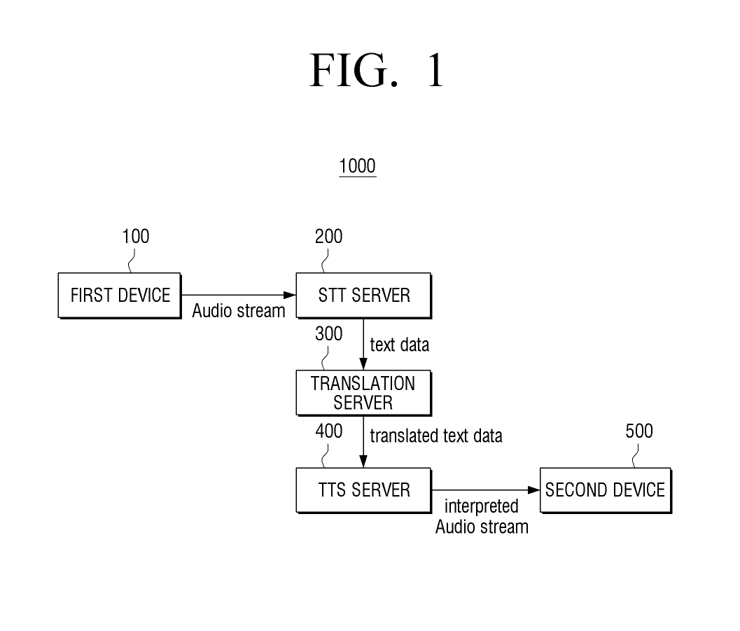

FIG. 1 is a block diagram which illustrates a configuration of an interpretation system, according to a first exemplary embodiment.

In the exemplary embodiments, it is assumed that two speakers using languages different from each other, converse with each other using their own language. An interpretation system 1000 according to the first exemplary embodiment translates a language of a speaker into a language of the other party, and provides the users with a translation in their own language. However, other modified examples exist and will be described later. For convenience of description, it is assumed that a first speaker is a user is speaking in Korean, and that a second speaker is speaking in English.

Speakers in an exemplary embodiment as described below utter a sentence through their own devices, and listen in a language of the other party interpreted through a server. However, modules in exemplary embodiments may be a partial configuration of the devices, and any one of the devices may include all functions of the server.

Referring to FIG. 1, the interpretation system 1000 according to a first exemplary embodiment includes a first device 100 configured to collect a voice uttered by the first speaker, a speech to text (STT) server 200 configured to recognize the collected voice, and convert the collected voice which has been recognized into a text, a translation server 300 configured to translate a text sentence according to a voice recognition result, a text-to-speech (TTS) server 400 configured to restore the translated text sentence to the voice of the speaker, and a second device 500 configured to output a synthesized voice.

The first device 100 collects the voice uttered by the first speaker. The collection of the voice may be performed by a general microphone. For example, the voice collection may be performed by at least one microphone selected from the group consisting of a dynamic microphone, a condenser microphone, a piezoelectric microphone using a piezoelectric phenomenon, a carbon microphone using a contact resistance of carbon particles, an (non-directional) pressure microphone configured to generate an output in proportion to sound pressure, and a bidirectional microphone configured to generate an output in proportional to velocity of negative particles. The microphone may be included in a configuration of the first device.

The collection period of time may be adjusted every time by operating a collecting device by the first speaker but the collection of the voice may be repeatedly performed for a predetermined period of time in the first device 100. The collection period of time may be determined by considering a period of time required for voice analysis and data transmission, and accurate analysis of a significant sentence structure. In contrast, the voice collection may be completed when a period in which the first speaker pauses for a moment during conversation, i.e., when a preset period of time has elapsed without voice collection. The voice collection may be constantly and repeatedly performed. The first device 100 may output an audio stream including the collected voice information which is sent to the STT server 200.

The STT server receives the audio stream, extracts voice information from the audio stream, recognizes the voice information, and converts the recognized voice information into text. Specifically, the STT server may generate text information which corresponds to a voice of a user using an STT engine. Here, the STT engine is a module configured to convert a voice signal into a text, and may convert the voice signal into the text using various STT algorithms which are known in the related art.

For example, the STT server may detect a start and an end of the voice uttered by the first speaker from the received voice of the first speaker in order to determine a voice interval. Specifically, the STT server may calculate the energy of the received voice signal, divide an energy level of the voice signal according to the calculated energy, and detect the voice interval through dynamic programming. The STT server may detect a phoneme, which is the smallest unit of a voice, in the detected voice interval based on an acoustic model in order to generate phoneme data, and may convert the voice of the first speaker into text by applying to the generated phoneme data a hidden Markov model (HMM) probabilistic model.

Further, the STT server 200 extracts a voice attribute of the first speaker from the collected voice. The voice attribute may include information such as a tone, an intonation, and a pitch of the first speaker. The voice attribute enables a listener (that is, the second speaker) to discriminate the first speaker through a voice. The voice attribute is extracted from a frequency of the collected voice. A parameter expressing the voice attribute may include energy, a zero-crossing rate (ZCR), a pitch, a formant, and the like. As a voice attribute extraction method for voice recognition, a linear predictive coding (LPC) method which performs modeling on a human vocal tract, a filter bank method which performs modeling on a human auditory organ, and the like, have been widely used. The LPC method has less computational complexity and excellent recognition performance in a quiet environment through using an analysis method in a time domain. However, the recognition performance in a noise environment is considerably degraded. As an analysis method for the voice recognition in the noise environment, a method of modeling a human auditory organ using a filter bank is mainly used, and Mel Frequency Cepstral Coefficient (MFCC) based on a Mel-scale filter bank may be mostly used as the voice attribute extraction method. According to psychoacoustic studies, it is known that a relationship between pitches of a physical frequency and a subject frequency recognized by human beings is not linear. By differentiating a physical frequency (f) is used which is expressed by ‘Hz,’ ‘Mel,’ which defines a frequency scale intuitively felt by human beings.

Further, the STT server 200 sets basic voice attribute information according to attribute information of a finally uttered voice. Here, the basic voice attribute information refers to features of voice output after translation is finally performed, and is configured of information such as a tone, an intonation, a pitch, and the like, of the output voice of the speaker. The extraction method of the features of the voice is the same as those of the voice of the first speaker, as described above.

The attribute information of the finally uttered voice may be any one of the extracted voice attribute information of the first speaker, pre-stored voice attribute information which corresponds to the extracted voice attribute information of the first speaker, and pre-stored voice attribute information selected by a user input.

A first method may sample a voice of the first speaker for a preset period of time, and may separately store an average attribute of the voice of the first speaker based on a sampling result, as detected information in a device.

A second method is a method in which voice attribute information of a plurality of speakers has been previously stored, and voice information which corresponds to or most similar to the voice attribute of the first speaker is selected from the voice attribute information.

A third method is a method in which a desired voice attribute is selected by the user, and when the user selects a voice of a favorite entertainer or character, attribute information related to the finally uttered voice is determined as a voice attribute which corresponds to the selected voice. At this time, an interface configured to select the desired voice attribute by the device user may be provided.

In general, the above-described processes of converting the voice signal into the text, and extracting the voice attribute may be performed in the STT server. However, since the voice data itself has to be transmitted to the STT server 200, the speed of the entire system may be reduced. When the first device 100 has high hardware performance, the first device 100 itself may include the STT module 251 having a voice recognition and speaker recognition function. At this time, the process of transmitting the voice data is unnecessary, and thus the period of time for interpretation is reduced.

The STT server 200 transmits to the translation server 300 the text information according to voice recognition and basic voice attribute information set according to the attribute information of the finally uttered voice. As described above, since the information for a sentence uttered by the first speaker is transmitted not in an audio signal but as text information and a parameter value, the amount of data transmitted may be drastically reduced. Unlike in another exemplary embodiment, the STT server 200 may transmit the voice and the text information according to the voice recognition to the second device 500. Since the translation server 300 does not require the voice attribute information, the translation server 300 may only receive the text information, and the voice attribute information may be transmitted to the second device 500, or the TTS server 400, to be described later.

The translation server 300 translates a text sentence according to the voice recognition result using an interpretation engine. The interpretation of the text sentence may be performed through a method using statistic-based translation or a method using pattern-based translation.

The statistic-based translation is technology which performs automatic translation using interpretation intelligence learned using a parallel corpus. For example, in the sentence “Eating too much can lead to getting fat,” and “Eating many apples can be good for you,” “learn to eat and live,” the word meaning “eat” is repeated. At this time, in a corresponding English sentence, the word “eat” is generated with greater frequency than the other words. The statistic-based translation may be performed by collecting the word generated with high frequency or a range in sentence construction (for example, will eat, can eat, eat, . . . ) through a statistic relationship between an input sentence and a substitution passage, constructing conversion information for an input, and performing automatic translation.

In the technology, first, a generalization change for node expression of all sentence pairs of pre-constructed parallel corpus is performed. The parallel corpus refers to sentence pairs configured of a source language and a target language having the same meaning, and refers to data collection in which a great amount of sentence pairs are constructed to be used as learning data for the statistic-based automated translation. The generalization of node expression means a process of substitution on an analysis unit obtained through morpheme of an input sentence an analysis unit having a noun attribute by syntax analysis in a specific node type.

The statistic-based translation method checks whether a text type of a source-language sentence, and performs language analysis in response to the source-language sentence being input. The language analysis acquires syntax information in which a vocabulary in morpheme units and a part of speech are divided, and a syntax range for translation node conversion in a sentence, and generates the source-language sentence including the acquired syntax information and the syntax, in node units.

The statistic-based translation method finally generates a target language by converting the generated source-language sentence in node units into a node expression using the pre-constructed statistic-based translation knowledge.

The pattern-based translation method is called an automated translation system which uses pattern information in which a source language and translation knowledge used for conversion of a substitution sentence are described in syntax units together within a form of a translation dictionary. The pattern-based translation method may automatically translate the source-language sentence into a target-language sentence using a translation pattern dictionary including a noun phrase translation pattern, and the like, and various substitution-language dictionaries. For example, the Korean expression “capital of Korea” may be used as a substitution knowledge for generation of a substitution sentence such as “capital of Korea” by a noun phrase translation pattern having a type “[NP2] of [NP1]>[NP2] of [NP1].”

The pattern-based translation method may detect a context in conversation is made by performing semantic analysis on the converted text data. At this time, the pattern-based translation method may estimate a situation in which the conversation is made by considering the detected context; and thus, more accurate translation is possible.

Similar to the conversion of a voice signal, the text translation may also be performed not in the translation server 300, but in the first device 100 or the STT server 200.

When the text translation is completed, the translated text data (when a sentence uttered by the first speaker is translated, the translated text data is an English sentence) is transmitted the TTS server 400 together with information for a voice feature of a first speaker, and the set basic voice attribute information. The basic voice attribute information is held in the TTS server 400 itself and only identification information is transmitted. Thus since the information in which the sentence uttered by the first speaker is translated is transmitted in an audio signal as text information and a parameter value, the data transmission traffic may be drastically reduced. Similarly, the voice feature information and the text information according to voice recognition may be transmitted to the second device 500.

The TTS server 400 synthesizes the transmitted translated text (for example, the English sentence) in a voice in a language which may be understood by the first speaker by reflecting the voice feature of the first speaker and the set basic voice attribute information. Specifically, the TTS server 400 receives the basic voice attribute information set according to the finally uttered voice attribute information, and synthesizes the voice formed of the second language from the text data translated into the second language on the basis of the set basic voice attribute information. Then, the TTS server 400 synthesizes a final voice by modifying the voice synthesized in the second language according to the received voice attribute information of the first speaker.

The TTL server 400, first, linguistically processes the translated text. That is, the TTS server 400 converts a text sentence by considering a number, an abbreviation, and a symbol dictionary of the input text, and analyzes a sentence structure such as the location of a subject and a predicate in the input text sentence with reference to a part of a speech dictionary. The TTL server 400 transcribes the input sentence phonetically by applying phonological phenomena, and reconstructs the text sentence using an exceptional pronunciation dictionary with respect to exceptional pronunciations to which general pronunciation phenomena is not applied.

Next, the TTS server 400 synthesizes a voice through pronunciation notation information in which a phonetic transcription conversion is performed in a linguistic processing process, a control parameter of utterance speed, an emotional acoustic parameter, and the like. Until now, a voice attribute of the first speaker is not considered, and a basic voice attribute in preset in the TTS server 400 is applied. That is, a frequency is synthesized by considering a dynamics of preset phonemes, an accent, an intonation, a duration (end time of phonemes (the number of samples), start time of phonemes (the number of samples)), a boundary, a delay time between sentence components and preset utterance speed.

The accent expresses stress of an inside of a syllable indicating pronunciation. The duration is a period of time in which the pronunciation of a phoneme is held, and is divided into a transition section and a normal section. As factors affecting the determination of the duration, there are unique or average values of consonants and vowels, a modulation method and location of phoneme, the number of syllables in a word, a location of a syllable in a word, adjacent phonemes, an end of a sentence, an intonational phrase, final lengthening appeared in the boundary, an effect according to a part of speech which corresponds to a postposition, or an end of a word, and the like. The duration is implemented to guarantee a minimum duration of each phoneme, and to be nonlinearly controlled with respect to a duration of a vowel rather a consonant, a transition section, and a stable section. The boundary is necessary for reading by punctuating, regulation of breathing, and enhancement of understanding of a context. There is a sharp fall of a pitch due to a prosodic phenomenon appeared in the boundary, final lengthening in a syllable before the boundary, and a break in the boundary, and a length of the boundary is changed according to utterance speed. The boundary in the sentence is detected by analyzing a morpheme using a lexicon dictionary and a morpheme (postposition and an end of a word) dictionary.

The acoustic parameter affecting emotion may be considered. The acoustic parameter includes an average pitch, a pitch curve, utterance speed, a vocalization type, and the like, and has been described in “Cahn, J., Generating Expression in Synthesized Speech, M.S. thesis, MIT Media Lab, Cambridge, Mass., 1990.”

The TTS server 400 synthesizes a voice signal based on the basic voice attribute information, and then performs frequency modulation by reflecting a voice attribute of the first speaker. For example, the TTS server 400 may synthesize a voice by reflecting a tone or an intonation of the first speaker. The voice attribute of the first speaker is transmitted in a parameter such as energy, a ZCR, a pitch or a formant.

For example, the TTS server 400 may modify a preset voice by considering an intonation of the first speaker. The intonation is generally changed according to a sentence type (termination type ending). The intonation descends in a declarative sentence. The intonation descends just before a last syllable, and ascends in the last syllable in a Yes/No interrogative sentence. The pitch is controlled in a descent type in an interrogative sentence. However, a unique intonation of a voice of the first speaker may exist, and the TTS server 400 may reflect a difference value of parameters between a representative speaker and the first speaker, in voice synthesis.

The TTL server 400 transmits the voice signal translated and synthesized in the language of the second speaker to the second device 500 of the second speaker. In response to the second device 500 including a TTL module 510, the transmission process is unnecessary.

The second device 500 outputs a voice signal received through a speaker 520. To converse between the first speaker and the second speaker, the second device 500 may transmit the voice of the second speaker to the first device 100 through the same process as the above-described process.

According to the above-described exemplary embodiment, the translation is performed by converting the voice data of the first speaker into the text data and the data is transmitted and received together with the extracted voice attribute of the first speaker. Therefore, since the information for a sentence uttered by the first speaker is transmitted with less data traffic, efficient voice recovery is possible.

Hereinafter, various modified exemplary embodiments will be described. As described above, various servers described in the first exemplary embodiment may be a module included in the first device 100 or the second device 500.

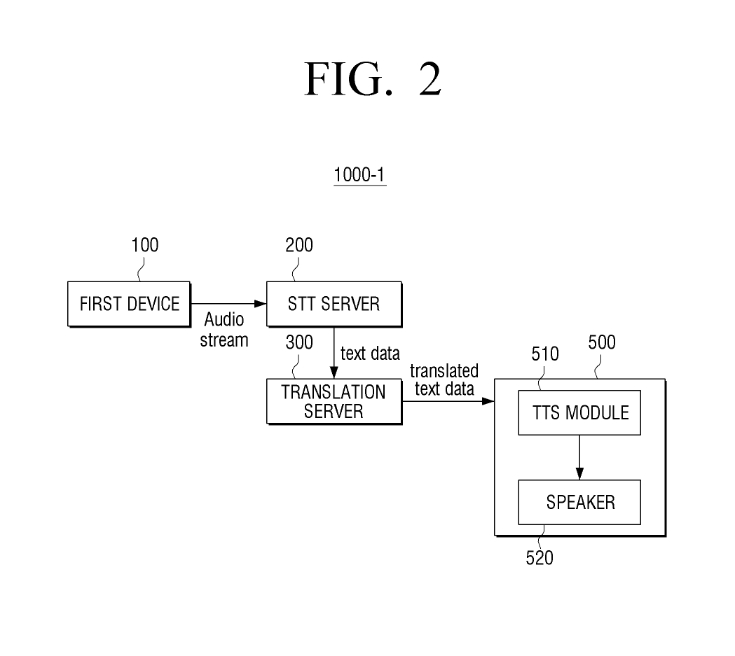

FIG. 2 is a view which illustrates a configuration of an interpretation system 1000-1 according to a second exemplary embodiment.

Referring to FIG. 2, the second exemplary embodiment is the same as the first exemplary embodiment, but it can be seen that the second device 500 includes the TTS module 510 and the speaker 520. That is, the second device 500 receives translated text (for example, a sentence in English) from a translation server 300, and synthesizes a voice in a language which may be understood by the second speaker by reflecting a voice attribute of the first speaker. The specific operation of the TTS module 510 is the same as in the above-described TTS server 400, and thus detailed description thereof will be omitted. The speaker 520 outputs a sentence synthesized in the TTS module 510. At this time, since the text information is mainly transmitted and received between the servers of the interpretation system 1000-1 and the device, fast and efficient communication is possible.

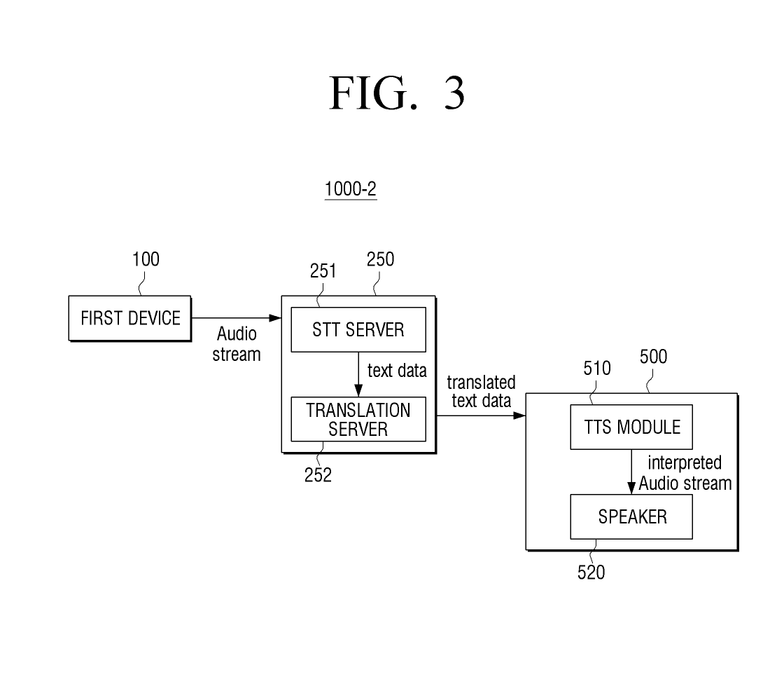

FIG. 3 is a view which illustrates a configuration of an interpretation system 1000-2 according to a second exemplary embodiment.

Referring to FIG. 3, the third exemplary embodiment is the same as the second exemplary embodiment, but it can be seen that the STT server 200 and the translation server 300 are integrated in functional modules 251 and 252 of one server 250. In general, when one server performs a translation function, efficient information processing is possible. At this time, since data transmission and reception operation through a network is omitted, data transmission traffic is further reduced, and thus efficient information processing is possible.

Hereinafter, a configuration of the first device 100 will be described.

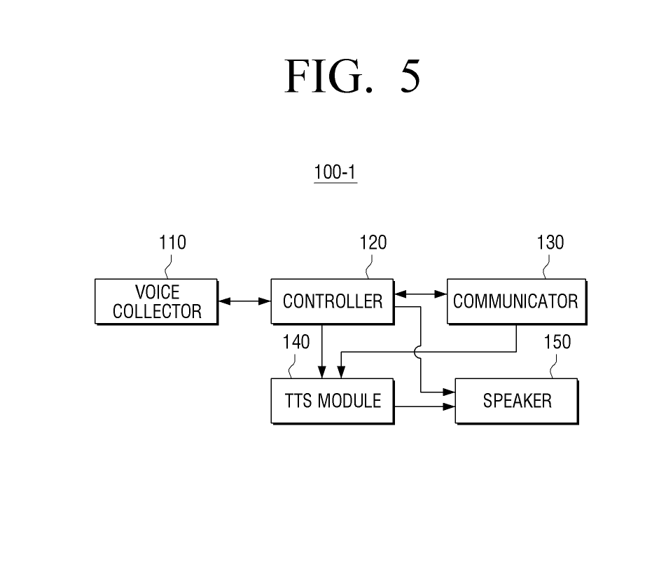

FIG. 5 is a block diagram illustrating a configuration of the first device 100 described in the above-described exemplary embodiments.

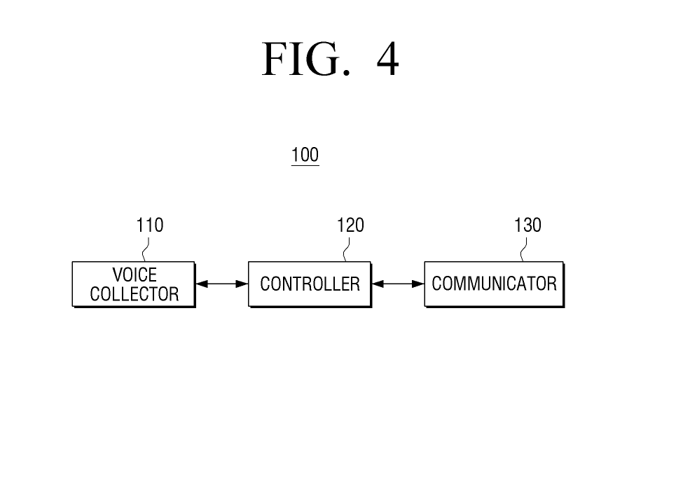

Referring to FIG. 4, the first device 100 includes a voice collector 110, a controller 120, and a communicator 130.

The voice collector 110 collects and records a voice of the first speaker. The voice collector 110 may include at least one microphone selected from the group consisting of a dynamic microphone, a condenser microphone, a piezoelectric microphone using a piezoelectric phenomenon, a carbon microphone using a contact resistance of carbon particles, an (non-directional) pressure microphone configured to generate an output in proportion to sound pressure, and a bidirectional microphone configured to generate an output in proportional to velocity of negative particles. The collected voice is transmitted to the STT server 200, and the like, through the communicator 130.

The communicator 130 is configured to communicate with various servers. The communicator 130 may be implemented with various communication techniques. A communication channel configured to perform communication may be Internet accessible through a normal Internet protocol (IP) address or a short-range wireless communication using a radio frequency. Further, a communication channel may be formed through a small-scale home wired network.

The communicator 130 may comply with a Wi-Fi communication standard. At this time, the communicator 130 includes a Wi-Fi module.

The Wi-Fi module performs short-range communication complying with the Institute of Electrical and Electronics Engineers (IEEE) 802.11 technology standard. According to the IEEE 802.11 technology standard, spread spectrum type wireless communication technology called single carrier direct sequence spread spectrum (DSSS) and an orthogonal frequency division multiplexing (OFDM) type wireless communication technology called multicarrier OFDM are used.

In another exemplary embodiment, the communicator 130 may be implemented with various mobile communication techniques. That is, the communication unit may include a cellular communication module which enables data to be transmitted and received using existing wireless telephone networks.

For example, third-generation (3G) mobile communication technology may be applied. That is, at least one technology among wideband code division multiple access (WCDMA), high speed downlink packet access (HSDPA), and high speed uplink packet access (HSUPA), and high speed packet access (HSPA) may be applied.

On the contrary, fourth generation (4G) mobile communication technology may be applied. Internet techniques such as 2.3 GHz (portable Internet), mobile WiMAX, and WiBro are usable even when the communication unit moves at high speed.

Further, 4G long term evolution (LTE) technology may be applied. LTE is extended technology of WCDMA and based on OFDMA and Multiple-Input Multiple-Output (MIMO) (multiple antennas) technology. The 4G LTE uses the WCDMA technology and is an advantage of using existing networks.

As described above, WiMAX, WiFi, 3G, LTE, and the like, which have wide bandwidth and high efficiency, may be used in the communicator 130 of the first device 130, but application of other short-range communication techniques may be not excluded.

That is, the communicator 130 may include at least one module from among other short-range communication modules, such as a Bluetooth module, an infrared data association (IrDa) module, a near field communication (NFC) module, a Zigbee module, and a wireless local area network (LAN) module.

The controller 120 controls an overall operation of the first device 100. In particular, the controller 120 controls the voice collector 110 to collect a voice of the first speaker, and packetizes the collected voice to match the transmission standard. The controller 120 controls the communicator 130 to transmit the packetized voice signal to the STT server 200.

The controller 120 may include a hardware configuration such as a central processing unit (CPU) or a cache memory, and a software configuration such as operating system, or applications for performing specific purposes. Control commands for the components are read to operate the display apparatus 100 according to a system clock, and electrical signals are generated according to the read control commands in order to operate the components of the hardware configurations.

The first device 100 may include all functions of the second device 500 for convenient conversation between the first speaker and a second speaker in the above-described exemplary embodiment. To the contrary, the second device 500 may also include all functions of the first device 100. This exemplary embodiment is illustrated in FIG. 5.

That is, FIG. 5 is a block diagram which illustrates a configuration of the first device 100 or the second device 500 in the above-described exemplary embodiments.

Referring further to FIG. 5, the first device 100 or the second device 500 a TTS module 140 and a speaker 150 in addition to the voice collector 110, the controller 120, and the communicator 130 described above. The components substantially have the same as those of the above-described exemplary embodiments with same name, and thus detailed description will be omitted.

Hereinafter, extended exemplary embodiments will be described.

In the above-described exemplary embodiments, for example, the first device 100 or the STT server 200 may automatically recognize a language of the first speaker. The automatic recognition is performed on the basis of a linguistic characteristic and a frequency characteristic of the language of the first speaker.

Further, the second speaker may select a language for translation desired by the second speaker. At this time, the second device 500 may provide an interface for language selection. For example, the second speaker uses English as a native language, but the second speaker may require Japanese interpretation to the second device for Japanese study.

Further, when a voice of a speaker is converted in a text and translation is performed, information for an original sentence and a translated sentence are stored in a storage medium. When the first speaker or the second speaker wants the information, the first speaker or the second speaker may use the stored information as language study, and the first device 100 or the second device 500 may include the function.

The interpretation system according the above-described exemplary embodiments may be applied to a video telephony system. Hereinafter, an exemplary embodiment in which the interpretation system is used in video telephony.

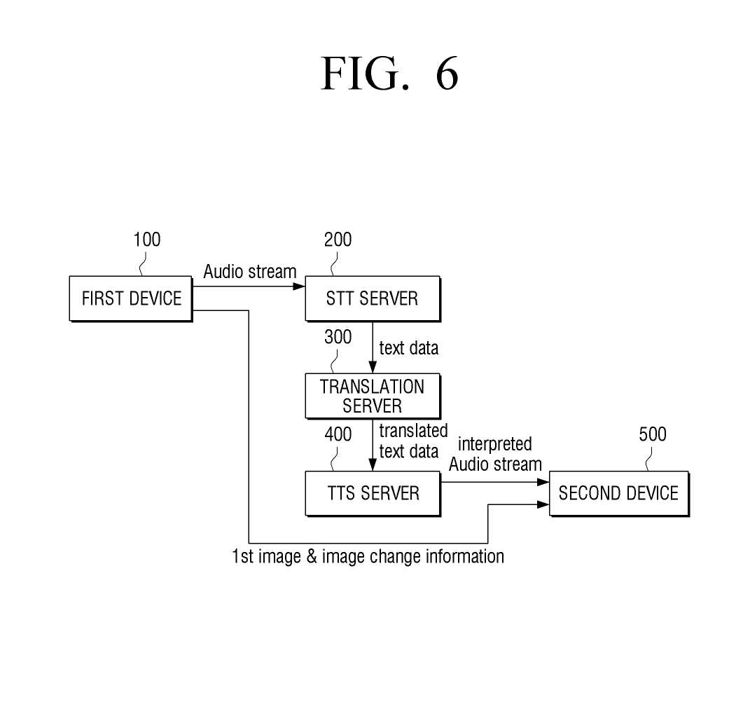

FIG. 6 is a view which illustrates an interpretation system according to a fourth exemplary embodiment.

As illustrated in FIG. 6, the first device 100 transmits video information of the first speaker to the second device 500. Other configuration of the interpretation system is the same as the first exemplary embodiment. However, the second and third exemplary embodiments may be similarly applied to video telephony.

Here, the video information may be image data imaging the first speaker. The first device 100 includes an image unit, and images the first speaker to generate the image data. The first device 100 transmits the imaged image data to the second device 500. The image data may be transmitted in preset short time units and output in the form of a moving image in the second device 500. At this time, the second speaker performing video telephony through the second device may call while watching an appearance of the first speaker in a moving image, and thus the second speaker may conveniently call like a direct conversation is being conducted. However, since the data transmission traffic is increased, transmission traffic occurs and increases a load in processing at a device terminal.

To address these problems, the interpretation system may only transmit the image first imaging the first speaker, and may then transmit only an amount of change in an image to the first image. That is, the first device 100 may image the first speaker and transmit the imaged image to the second device 500 when video telephony starts, and may then compare an image of the first speaker with the first transmitted image in order to calculate the amount of change of an object, and may transmit the calculated amount of change. Specifically, the first device identifies several objects which exist in the first image. Then, similarly, the first device identifies several objects which exist in next imaged image and compares the objects with the first image. The first device calculates an amount of movement of each object and transmits to the second device a value for the amount of movement of each object. The second device 500 applies the value of the amount of movement of each object to a first received image, and performs required interpolation on the value to generate next image. To generate a natural image, various types of interpolation methods and various sampling images for the first speaker may be used. The method may describe change in expression of the first speaker, a gesture, an effect according to an illumination, and the like, with less data transmission traffic in the device of the second speaker.

To further reduce the data transmission traffic, the image of the first speaker may be expressed as an avatar. A threshold value of the amount of change of images obtained from consecutive imaged images of the first speaker from the first image is set, and data is only transmitted when the obtained images are larger than the threshold value. Further, in response to the obtained images being larger than the threshold value, an expression or situation of the first speaker may be determined based on an attribute of the change. At this time, when the change in the image of the first speaker is larger, the first device determines a state of the change of the first speaker, and transmits to the second device 500 only information related to the change state of the first speaker. For example, in response to a determination that the first speaker has an angry expression, the first device 100 only transmits to the second device 500 information related to the angry expression. The second device may receive only simple information related to the situation of the first speaker and may display an avatar image of the first speaker matching the received information. The exemplary embodiment may drastically reduce the amount of data transmission, and may provide the user with something that is fun.

The above-described general communication techniques may be applied to the image data transmission between the first device 100 and the second device 500. That is, short-range communication, mobile communication, and long-range communication may be applied and the communication techniques may be complexly utilized.

On the other hand, the voice data and the image data may be separately transmitted, and a difference in data capacity between the voice data and the video data may exist, and communicators used may be different from each other. Therefore, there is a synchronization issue when the voice data and the video data are to be transmitted finally output in the second device 500 of the second speaker. Various synchronization techniques may be applied to the exemplary embodiments. For example, a time stamp may be displayed in the voice data and the video data, and may be used when the voice data and the video data are output in the second device 500.

The interpretation systems according to the above-described exemplary embodiments may be applied to various fields as well as video telephony. For example, when subtitles in a second language are provided to a movie dubbed in a third language, a user of a first language watches the movie in a voice interpreted in the first language. At this time, a process of recognizing the third language and converting the text is omitted, and therefore a structure of the system is further simplified. The interpretation system translates the subtitles into the second language, and generates the text data in the first language, and the TTS server 400 synthesizes the generated text into a voice. As described above, the voice synthesis in a specific voice according to preset information may be performed. For example, the voice synthesis in his/her own voice or a celebrity's voice according to preset information may be provided.

Hereinafter, interpretation methods according to various exemplary embodiments will be described.

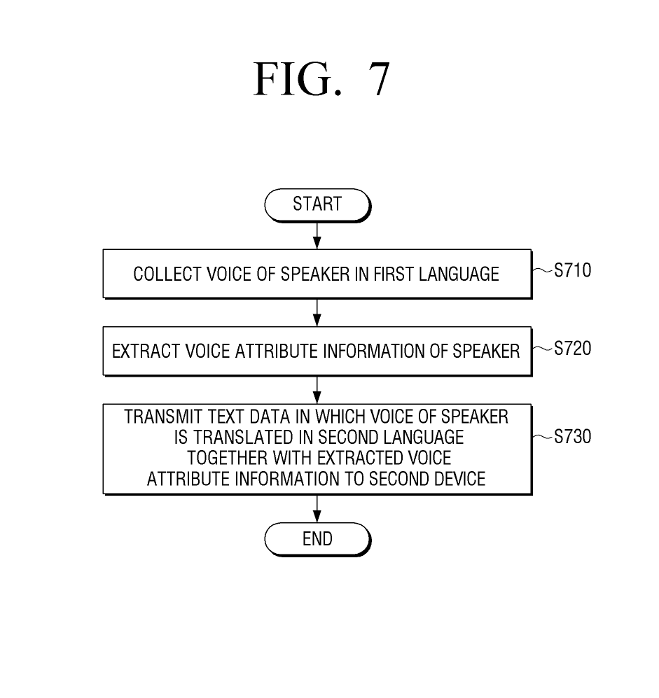

FIG. 7 is a flowchart which illustrates an interpretation method of the first device according to another exemplary embodiment.

Referring to FIG. 7, the interpretation method of the first device according to another exemplary embodiment includes collecting a voice of a speaker in a first language to generate voice data (S710), extracting voice attribute information of the speaker from the generated voice data (S720), and transmitting to the second device text data in which the voice of the speaker in the generated voice data is translated in second language together with the extracted voice attribute information (S730). At this time, the text data translated in the second language may be generated by recognizing the voice of the speaker included in the generated voice data, converting the recognized voice of the speaker into the text data, and translating the converted text data in the second language.

The voice attribute information of the speaker may include at least one attribute selected from the group consisting of dynamics, an accent, an intonation, a duration, a boundary, a delay time between sentence configurations, and utter speed in the voice of the speaker. The voice attribute information of the speaker may be expressed by at least one attribute selected from the group consisting of energy, a zero-crossing rate (ZCR), a pitch, and a formant in a frequency of the voice data.

The translating in the second language may include performing a semantic analysis on the converted text data to detect context in a conversation, and translating the text data in the second language by considering the detected context. As described above, the process may be performed by a server or by the first device.

The transmitting may include transmitting the generated voice data to require translation, receiving the text data, in which the generated voice data converted into text data, and the converted text data is converted in the second language again, from the server; and transmitting to the second device the received text data together with the extracted voice attribute information.

The interpretation method may further include imaging the speaker to generate a first image; imaging the speaker to generate a second image, and detecting change information from the first image in the second image; and transmitting to the second device the detected change information.

The interpretation method may further include transmitting to the second device to the second device synchronization information for output synchronization between voice information included in the text data translated in the second language and image information included in the first image or the second image.

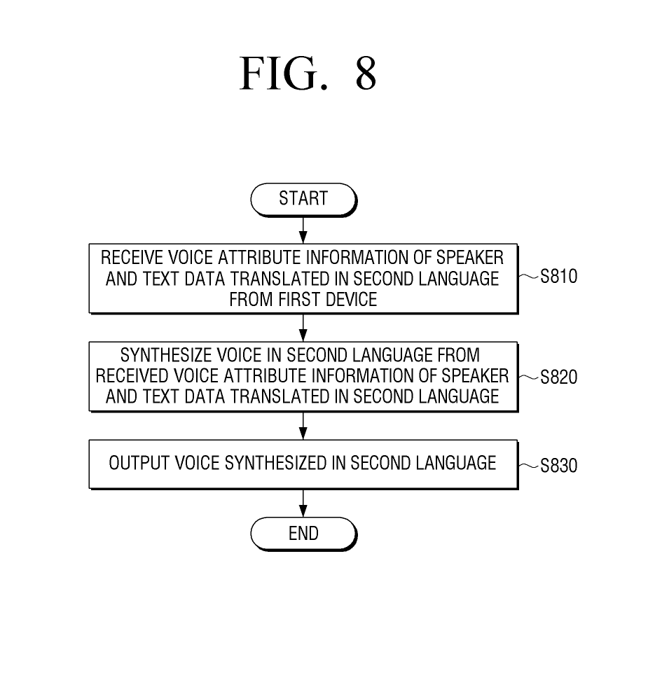

FIG. 8 is a flowchart which illustrates a method of interpretation of the second device, according to another exemplary embodiment.

Referring to FIG. 8, the interpretation method of the second device according to another exemplary embodiment includes receiving from the first device text data translated in a second language together with voice attribute information (S810), synthesizing a voice of the second language from the received attribute information and the text data translated in the second language (S820), and outputting the voice synthesized in the second language (S830).

The voice attribute information of the speaker may include at least one attribute selected from the group consisting of a dynamics, an accent, an intonation, a duration, a boundary, a delay time between sentence configurations, and utter speed in the voice of the speaker. The voice attribute information of the speaker may be expressed by at least one attribute selected from the group consisting of energy, a zero-crossing rate (ZCR), a pitch and a formant in a frequency of the voice data.

The control method may further include receiving a first image generated by imaging the speaker, and change information between the first image and a second image generated by imaging the speaker; and displaying an image of the first speaker based on the received first image and the change information.

The displayed image of the first speaker may be an avatar image.

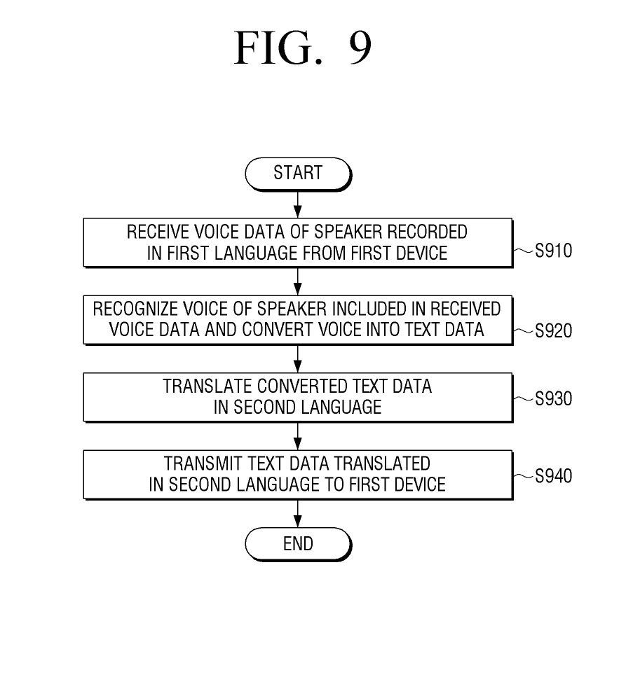

FIG. 9 is a flowchart which illustrates a method of interpretation of a server, according to another exemplary embodiment.

Referring to FIG. 9, the interpretation method of a server include receiving voice data of a speaker recorded in a first language from the first device (S910), recognizing a voice of the speaker included in the received voice data and converting the recognized voice of the speaker into text data (S920), translating the converted text data in a second language (S930), and transmitting to the first device the text data translated in the second language (S940).

The translating may include performing a semantic analysis on the converted text data in order to detect context in a conversation, and translating the text data in the second language by considering the detected context.

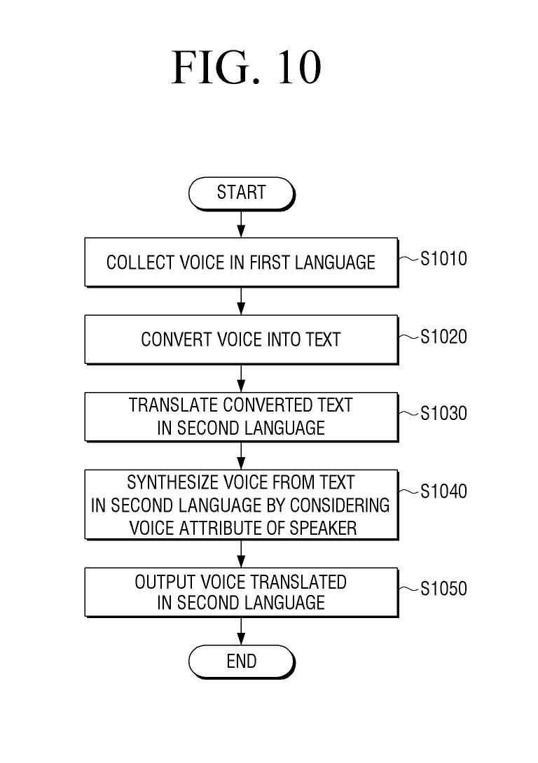

FIG. 10 is a flowchart which illustrates a method of interpretation method of an interpretation system, according to another exemplary embodiment.

Referring to FIG. 10, the interpretation method of the interpretation system includes collecting a voice of a speaker in a first language in order to generate voice data in a first device (S1010), and extracting voice attribute information of the speaker from the generated voice data, receiving the voice data recorded in the first language from the first device, recognizing the voice of the speaker included in the received voice data, and converting the recognized voice of the speaker into text data, in a speech to text (STT) server (S1020), receiving the converted text data, translating the received text data in a second language, and transmitting the text data translated in the second language to the first device, in the interpretation server (S1030), operation (not shown) of transmitting the text data translated in the second language together the voice attribute information of the speaker to the second device, synthesizing a voice in the second language from the voice attribute information and the text data translated in the second language (S1040), and outputting a synthesizing voice (S1050).

The above-described interpretation method may be recorded in program form in a non-transitory computer-recordable storage medium. The non-transitory computer-recordable storage medium is not a medium configured to temporarily store data such as a register, a cache, a memory, and the like, but rather refers to an apparatus-readable storage medium configured to semi-permanently store data. Specifically, the above-described applications or programs may be stored and provided in the non-transitory electronic device-recordable storage medium such as a compact disc (CD), a digital versatile disc (DVD), a hard disc, a Blu-ray disc, a universal serial bus (USB), a memory card, a read only memory (ROM), and the like. The storage medium may be implemented with a variety of recording media such as a CD, a DVD, a hard disc, a Blu-ray disc, a memory card, and a USB memory.

The interpretation method may be built in a hardware integrated circuit (IC) chip embedded in software, or may be provided in firmware.

The foregoing exemplary embodiments and advantages are merely exemplary and are not to be construed as limiting. The exemplary embodiments can be readily applied to other types of devices. Also, the description of the exemplary embodiments is intended to be illustrative, and not to limit the scope of the claims, and many alternatives, modifications, and variations will be apparent to those skilled in the art.

What is claimed is:

1. A method of controlling an interpretation apparatus, the method comprising:
collecting a voice of a speaker in a first language to generate voice data;
extracting from the generated voice data voice attribute information of the speaker; and
transmitting to an external apparatus text data in which the voice of the speaker included in the generated voice data is translated in a second language, together with the extracted voice attribute information,
wherein the text data translated in the second language is generated by recognizing the voice of the speaker included in the generated voice data, converting the recognized voice of the speaker into the text data, and translating the converted text data into the second language.

2. The method as claimed in claim 1, further comprising:
setting basic voice attribute information according to attribute information of finally uttered information; and
transmitting to the external apparatus the set basic voice attribute information,
wherein each of the basic voice attribute information and the voice attribute information of the speaker includes at least one attribute selected from the group consisting of a dynamics, an accent, an intonation, a duration, a boundary, a delay time between sentence configurations, and utterance speed in the voice of the speaker, and is expressed by at least one attribute selected from the group consisting of energy in a frequency of the voice data, a zero-crossing rate (ZCR), a pitch and a formant.

3. The method as claimed in claim 1, further comprising:
setting basic voice attribute information according to attribute information of a finally uttered information; and
transmitting to the external apparatus the set basic voice attribute information,
wherein the finally uttered voice attribute information is any one attribute selected from the group consisting of the extracted voice attribute information of the speaker, pre-stored voice attribute information which corresponds to the extracted voice attribute information of the speaker and pre-stored voice attribute information selected through a user input.

4. The method as claimed in claim 1, wherein the voice attribute information is translated in the second language by performing a semantic analysis on the converted text data to detect a context in which a conversation is done, and by considering the detected context.

5. The method as claimed in claim 1, wherein the transmitting includes:
transmitting the generated voice data to a server to require translation,
receiving from the server text data, in which the generated voice data converted into text data, and the converted text data is converted in the second language again; and
transmitting to the external apparatus the received text data together with the extracted voice attribute information.

6. The method as claimed in claim 1, further comprising:
imaging the speaker to generate a first image;
imaging the speaker to generate a second image, and detecting change information in the second image from comparison with the first image; and
transmitting to the external apparatus the first image and the detected change information.

7. The method as claimed in claim 6, further comprising transmitting to the external apparatus synchronization information for output synchronization between voice information included in the text data translated in the second language and image information included in the first image or the second image.

8. A method of controlling an interpretation apparatus, the method comprising:
receiving from an external apparatus text data translated in a second language together with voice attribute information of a speaker;
synthesizing a voice in the second language from the received voice attribute information of the speaker and the text data translated in the second language; and
outputting the voice synthesized in the second language.

9. The method as claimed in claim 8, further comprising receiving from the external apparatus basic voice attribute information set according to attribute information of a finally uttered voice,
wherein the synthesizing the voice includes:
synthesizing the voice in the second language from the text data translated in the second language on the basis of the set basic voice attribute information; and
synthesizing a final voice by modifying the voice synthesized in the second language according to the received voice attribute information of the speaker.

10. The method as claimed in claim 9, wherein each of the basic voice attribute information and the voice attribute information of the speaker includes at least one attribute selected from the group consisting of dynamics, an accent, an intonation, a duration, a boundary, a delay time between sentence configurations, and utterance speed in the voice of the speaker, and is expressed by at least one of a frequency of the voice data, a zero-crossing rate (ZCR), a pitch, and a formant.

11. The method as claimed in claim 8, further comprising:
receiving a first image generated by imaging the speaker, and change information between the first image and a second image generated by imaging the speaker; and
displaying an image of the speaker based on the received first image and the change information.

12. A method of controlling an interpretation apparatus, the method comprising:
generating text data by translating caption data in a first language into a second language;
synthesizing a voice in the second language from the generated text data translated in the second language according to preset voice attribute information; and
outputting the synthesized voice in the second language.

13. The method as claimed in claim 12, further comprising:
receiving a user input for selecting attribute information of a finally uttered voice; and
selecting the attribute information of the finally uttered voice based on the received user input,
wherein the attribute information of the finally uttered voice includes at least one attribute selected from the group consisting of a dynamics, an accent, an intonation, a duration, a boundary, a delay time between sentence configurations, and utterance speed in the voice of the speaker, and is expressed by at least one attribute selected from the group consisting of energy in a frequency of the voice data, a zero-crossing rate (ZCR), a pitch, and a formant.

14. A method of controlling an interpretation apparatus, the method comprising:
collecting a voice of a speaker in a first language to generate voice data, and extracting voice attribute information of the speaker from the generated voice data, in a first device:
receiving the voice data of the speaker uttered in the first language from the first device, recognizing the voice of the speaker included in the received voice data, and converting the recognized voice of the speaker into text data, in a speech to text (STT) server;
receiving the converted text data, translating the received text data in a second language, and transmitting the text data translated in the second language to the first device, in a translation server;
transmitting the text data translated in the second language together the voice attribute information of the speaker to a second device, from the first device; and
synthesizing a voice in the second language from the voice attribute information of the speaker and the text data translated in the second language, and outputting the voice synthesized in the second language, in the second device.

15. A user terminal comprising:
a voice collector configured to collect a voice of a speaker in a first language to generate voice data;
a communication unit configured to communicate with another user terminal; and
a controller configured to control to extract voice attribute information of the speaker from the generated voice data, and to transmit text data, in which the voice of the speaker included in the generated voice data is translated in a second language, together with the extracted voice attribute information to the other user terminal,
wherein the text data translated in the second language is generated by recognizing the voice of the speaker included in the generated voice data, converting the recognized voice of the speaker into the text data, and translating the converted text data in the second language.

16. The user terminal as claimed in claim 15, wherein the controller is configured to set basic voice attribute information according to attribute information of a finally uttered voice, and to transmit to the external apparatus the set basic voice attribute information,
wherein each of the basic voice attribute information and the voice attribute information of the speaker includes at least one of dynamics, an accent, an intonation, a duration, a boundary, a delay time between sentence configurations, and utterance speed in the voice of the speaker, and is expressed by at least one of energy in a frequency of the voice data, a zero-crossing rate (ZCR), a pitch and a formant.

17. The user terminal as claimed in claim 15, wherein the controller is configured to transmit the generated voice data to a server to require translation, to receive text data in which the generated voice data is converted into text data, and the converted text data is converted by the server into the second language again; and to transmit the received text data to the other user terminal, together with the extracted voice attribute information.

18. The user terminal as claimed in claim 15, wherein the controller is configured to detect change information in a second image of the speaker from a first image of the speaker, and to transmit the first image and the detected change information to the other user terminal.

19. The user terminal as claimed in claim 15, wherein the controller is configured to transmit to the other user terminal synchronization information for output synchronization between voice information included in the text data translated in the second language and image information included in the first image or the second image.

20. A user terminal comprising:
a communicator configured to receive text data translated in a second language together with voice attribute information of a speaker from another user terminal; and
a controller configured to synthesize a voice in the second language from the received voice attribute information of the speaker, and the text data in the second language, and to output the synthesized voice.
